(19) United States
(12) Patent Application Publication
(10) Pub. No.: US 2014/0268714 A1
(43) Pub. Date: Sep. 18, 2014

(54) FLASHLIGHT ATTACHMENT APPARATUS

(71) Applicant: Jason Hui, Menlo Park, CA (US)

(72) Inventor: Jason Hui, Menlo Park, CA (US)

(21) Appl. No.: 14/043,744

(22) Filed: Oct. 1, 2013

Related U.S. Application Data
(60) Provisional application No. 61/786,496, filed on Mar. 15, 2013.

(51) Int. Cl. A44B 15/00; F21L 4/00

(52) U.S. Cl. CPC A44B 15/00; F21L 4/00
USPC 362/208; 29/428

(57) ABSTRACT

Embodiments generally relate to providing a flashlight attachment apparatus. The flashlight attachment apparatus includes a first cavity and a reversible attachment mechanism. The reversible attachment mechanism cavity comprises a first portion, configured to mate with the first cavity, and a second portion configured to mate with a holding device. The reversible attachment mechanism may include a spring. The holding device may be a key-ring.

### CROSS REFERENCES TO RELATED APPLICATIONS

This application claims priority from U.S. Provisional Patent Application Ser. No. 61,786,496, entitled “Flashlight Attachment Apparatus”, filed on Mar. 15, 2013, which is hereby incorporated by reference as if set forth in full in this application for all purposes.

### BACKGROUND

There are many circumstances in which providing the option of a reversible attachment mechanism to link a flashlight to a holding device would be attractive, especially for a compact flashlight whose low weight could be supported by a standard key-ring. Simple approaches, such as providing a hole, near one end of the flashlight housing, through which a split ring could be threaded, are undesirable, as the threading and unthreading actions required of the user are relatively awkward and time-consuming processes, given the typical sizes and shapes of currently available flashlight housings.

### SUMMARY

Embodiments generally relate to providing a flashlight attachment apparatus. In one embodiment, a flashlight attachment apparatus includes a first cavity and a reversible attachment mechanism. The reversible attachment mechanism comprises a first portion, configured to mate reversibly with the first cavity, and a second portion configured to mate with a holding device.

In another embodiment, a method includes modifying a standard compact flashlight housing by creating a cavity, configured to allow reversible mating with a first portion of a reversible attachment mechanism, in one end of the housing. A second portion of the reversible attachment mechanism is configured to mate with a holding device.

### BRIEF DESCRIPTION OF THE DRAWINGS

FIG. 1 is a schematic longitudinal-section of an example flashlight attachment apparatus according to some embodiments.

FIG. 2 is a schematic longitudinal-section of a portion of an example flashlight attachment apparatus, according to some embodiments

FIG. 3 is a schematic longitudinal-section of a portion of an example flashlight attachment apparatus, according to some embodiments

### DETAILED DESCRIPTION

Embodiments described herein enable a user to easily attach and detach a flashlight from a holding device. The option of an easily reversible attachment mechanism is likely to be particularly useful for compact flashlights, allowing them to be carried on or about the person, attached to a holder, that is already in the user's possession serving other purposes, such as a key-ring holding keys.

Some embodiments provide a flashlight attachment apparatus including a mechanism that depends on the user-controlled compression and release of a coil spring within the mechanism to quickly release or attach the mechanism from the flashlight housing. In some embodiments the mechanism depends on the user-controlled displacement of one or more balls within the mechanism to quickly release or attach the mechanism from the flashlight housing.

Various embodiments described below with particular reference to FIG. 1 through FIG. 3 allow such flashlight attachment apparatuses and methods of providing such apparatuses to be realized.

FIG. 1 is a schematic view of an example flashlight attachment apparatus according to some embodiments, shown in longitudinal-section. Flashlight attachment apparatus 100 comprises flashlight housing 102, which in turn comprises a first cavity 104 and a reversible attachment mechanism 106. Reversible attachment mechanism 106 has a first portion, 108, which is configured to reversibly mate with first cavity 104, and a second portion 110, which is configured to mate with a holding device, such as key-ring 112. Mating with a holding device is preferably, but not necessarily, reversible.

Omitted from FIG. 1 for simplicity are other components that may be contained in flashlight housing 102. In some embodiments, housing 102 may comprise a second cavity 114, typically housing a light emitting device, a power source including one or more batteries, and associated electronic circuitry.

FIG. 2 is a zoomed-in schematic view of the example flashlight attachment apparatus of FIG. 1, showing components 202, 204, and 206 of reversible attachment mechanism 106. Component 202 is a coil spring, components 204 are spherical balls, and component 206 is a shaft. Balls 204 hold mechanism 106 tightly against the inner wall of housing 102 when spring 202 is relaxed. When a user applies pressure to compress spring 202, shaft 206 moves downwards, and the balls 204 move radially toward the axis of shaft 206, breaking the connection between mechanism 106 and housing 102, allowing mechanism 106 and housing 102 to be separated. When a user wishes to reattach mechanism 106 and housing 102, the user again applies pressure to compress spring 202, allowing shaft 206 to be reinserted into cavity 104 to reach the position at which, on releasing pressure, the balls move radially outwards and latch mechanism 106 and housing 102 together.

In some embodiments, coil spring 202 may be replaced by another type of spring. The word “spring” is defined herein to include any “spring-like” element or device that tends to return to its original shape and configuration after being distorted by an applied force. Gas compression, hydraulic forces, the use of rubber or elastomeric materials, or even magnetic forces may be involved.

In some embodiments, only one ball 204 may be present, but load-balancing considerations would generally favor the use of two or more.

The particular arrangements shown in FIG. 1 and FIG. 2 are particularly desirable, as they make use of a type of “quick-release” mechanism already widely available at low cost for applications such as joining two key-rings together, each ring holding a set of keys which may occasionally need to be separated.

FIG. 3 is a schematic view of an example flashlight attachment apparatus according to some other embodiments in which a canted coil spring 302 is seated in a recess 304 in the wall of flashlight housing 306 around cavity 308. When axial pressure is applied in the direction shown in the figure, to the shaft 310 of mechanism 312, spring 302 may be distorted sufficiently to allow shaft 310 to pass through. Spring 302 can subsequently form a secure seal around that shaft by fitting into a complementary recess 314 on shaft 310. Pulling back on shaft 310 in the reverse direction to that shown in the figure will release spring 302 from recess 314, allowing mechanism 312 to be separated from flashlight housing 306, while spring 302 returns to its relaxed state.

In some embodiments, the housing of a standard flashlight may be modified by creating a cavity, such as that shown as first cavity 104 in FIG. 1, in one end of the housing. As described above with respect to FIG. 1, first cavity 104 is shaped and sized to allow reversible mating with a first portion 108 of reversible attachment mechanism 106. A second portion 110 of reversible attachment mechanism 106 is configured to mate with a holding device.

In some embodiments, a reversibly attachable flashlight system may be provided by modifying the housing of a standard flashlight system as discussed above, and providing the reversible attachment mechanism and the modified flashlight system, to the user.

In some embodiments, a flashlight housing may be manufactured from “scratch”, creating a cavity as described above, without first obtaining a standard flashlight housing.

In some embodiments, an “opposite” arrangement of the one shown in FIG. 1 may be envisaged, in which a reversible attachment mechanism is securely attached to a flashlight housing, and one portion of that attachment mechanism is configured to reversibly mate with a cavity in a separate clasp mechanism. In such embodiments, a portion of the clasp mechanism is configured to mate with a holding device.

Embodiments described herein provide various benefits. In particular, embodiments enable a user to quickly and easily attach and detach a flashlight from a holder that may, for example, be a key-ring kept at some fixed location, or placed in a vehicle, or carried by the user in a pocket, wallet, or case. These benefits may be especially convenient for a user who routinely carries a key-ring, and may occasionally find a compact hand-held flashlight helpful.

Although the description has been described with respect to particular embodiments thereof, these particular embodiments are merely illustrative, and not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in”, “on”, and “in close proximity to” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A flashlight attachment apparatus comprising:
a flashlight housing comprising a first cavity; and
a reversible attachment mechanism comprising:
a first portion configured to reversibly mate with the first cavity; and
a second portion configured to mate with a holding device.

2. The flashlight attachment apparatus of claim 1, wherein the reversible attachment mechanism includes a spring.

3. The flashlight attachment apparatus of claim 2,
wherein the spring includes a coil spring; and
wherein the first portion of the reversible attachment mechanism includes one or more substantially spherical balls; and
wherein the second portion of the reversible attachment mechanism includes a shaft configured to compress the coil spring in response to pressure applied by a user.

4. The flashlight attachment apparatus of claim 1, further comprising a canted coil spring housed within the first cavity, wherein the canted coil spring is configured to latch and hold the first portion of the reversible attachment mechanism in response to pressure applied to the first portion of the reversible attachment mechanism by a user.

6. The flashlight attachment apparatus of claim 1, wherein the holding device is a key-ring.

7. The flashlight attachment apparatus of claim 1, further comprising:
a second cavity configured to house a power source,
electronic circuitry, and a light emitting device.

8. A method of modifying a standard compact flashlight housing, the method comprising:
creating a cavity, configured to allow reversible mating with a first portion of a reversible attachment mechanism, in one end of the housing;
wherein a second portion of the reversible attachment mechanism is configured to mate with a holding device.

10. The method of claim 8,
wherein the second portion of the reversible attachment mechanism includes one or more substantially spherical balls; and
wherein the configuring comprises shaping and sizing the cavity to allow mating with the one or more substantially spherical balls.

11. The method of claim 8, wherein the configuring comprises shaping and sizing the cavity to hold a canted coil spring.

12. A method of modifying a flashlight system having a flashlight housing to provide a reversibly attachable flashlight system, the method comprising;
modifying the flashlight housing by creating a cavity, configured to allow reversible mating with a first portion of a reversible attachment mechanism, in one end of the flashlight housing; and
providing the reversible attachment mechanism and the flashlight system including the modified housing to the user;
wherein a second portion of the reversible attachment mechanism is configured to mate with a holding device.

13. A flashlight attachment apparatus comprising:
a clasp mechanism comprising a cavity and a portion configured to mate with a holding device; and
a flashlight housing comprising a reversible attachment mechanism fixed within the flashlight housing and configured to reversibly mate with the cavity.

14. A method of manufacturing a flashlight housing, the method comprising:
creating a cavity, configured to allow reversible mating with a first portion of a reversible attachment mechanism, in one end of the housing;
wherein a second portion of the reversible attachment mechanism is configured to mate with a holding device.

15. A method of manufacturing a flashlight attachment apparatus, the method comprising:
creating a flashlight housing comprising a reversible attachment mechanism fixed within the housing; and
creating a cavity, configured to allow reversible mating with the reversible attachment mechanism, in one end of a clasp mechanism;
wherein a second portion of the clasp mechanism is configured to mate with a holding device.
